(19) United States
(12) Patent Application Publication
(10) Pub. No.: US 2023/0020081 A1
(43) Pub. Date: Jan. 19, 2023

(54) MECHANICAL SYSTEM FOR SECURING EXERCISE EQUIPMENT TO A SMOOTH FLOOR SURFACE UTILIZING LOCKABLE SUCTION CUPS

(71) Applicant: Product Design Innovations, LLC, Ocala, FL (US)

(72) Inventor: Joseph K. Ellis, Ocala, FL (US)

(73) Assignee: Product Design Innovations, LLC, Ocala, FL (US)

(21) Appl. No.: 17/374,067

(22) Filed: Jul. 13, 2021

(51) Int. Cl. F16B 47/00; A63B 71/04

(52) U.S. Cl. CPC F16B 47/006; A63B 71/04

(57) ABSTRACT

A mechanical system for adhering various types of exercise equipment to a smooth floor surface, the system having lockable suction cups that are attached to a first planar portion of the exercise equipment to adhere the exercise equipment to the smooth floor surface when the exercise equipment is in an operational position. Additional lockable suction cups can be attached to a second planar portion of the exercise equipment to adhere the exercise equipment to the smooth floor surface when the exercise equipment is in a storage position. The lockable suction cups support at least a portion of the exercise equipment in the operational or storage positions.

### BACKGROUND OF THE INVENTION

### Technical Field

This invention relates to the general technical field of exercise equipment products and how these various products are secured to a floor surface. This invention relates more specifically to the field of exercise equipment products utilizing lockable suction cups integrated into the equipment's structural frame to secure the equipment to a smooth floor surface.

### Prior Art

Exercise equipment is available in various configurations and for various purposes. Various types of exercise equipment include cardiovascular training products such as a treadmill or stationary bike for example as well as strength training products such as benches and racks used for body weight exercises or to support a user and a barbell or dumbbells. Strength training products can also include weight stack resisted exercise machines for engaging various muscle groups such as a leg extension machine for example. Strength training products can also be configured with various alternative resistance means other than a weight stack including a flywheel for example.

Many exercise equipment products weigh hundreds of pounds and may have a small foot print relative to their height. Also, the configuration and function of some exercise equipment products may require the center of gravity to be elevated a distance off of the floor sufficient to cause some exercise equipment products to become unstable when engaged by a user or bystander. Some exercise equipment products are designed to be placed in a first position such as a horizontal configuration during operation and may be reoriented to a second position for storage such as a vertical configuration when not in use to save space. However, this vertical storage configuration can cause certain exercise equipment products to be even less stable and more easily tipped over.

According to the US Consumer Products Safety Counsel, every year thousands of injuries are caused by exercise equipment products with many involving improper use but many involve instability of the equipment and machines. For example, in the 2011 lawsuit; Barnhard vs. Cybex Intl. Inc., the plaintiff Barnhard was injured when a Cybex brand leg extension machine tipped over on Barnhard while Barnhard was engaging the machine causing Barnhard permanent debilitating paralysis. A jury found Cybex Intl., Inc. to be at fault in the case resulting in Barnhard being awarded $19.5M in damages from Cybex Intl., Inc.

In other situations involving the use of exercise equipment, some users can exert a large amount of force while using certain exercise equipment products causing these products to become unstable and move about on a floor surface creating an undesirable situation that could be dangerous or create other problems such as dislodging the products electrical cord from the power outlet. The solution exercise equipment manufacturers have previously offered for securing their products to a floor surface is to provide a through hole in the lower portion of the structural frame of certain products such that the purchaser of these products is required to fasten these products to their floor by inserting a screw or bolt fastener through these through holes and inserting these fasteners into their floor surface. This is very impractical as this fastening process requires specialized skills, tools, machinery and added cost. Also, most purchasers of these products do not want to drill holes or insert fasteners in the floors of their homes or exercise facilities. The result is that very few exercise equipment products are adhered to and safely secured to the floor surface in the homes or facilities in which they are operated causing the afore mentioned problems.

The present invention offers a fast, simple and cost-effective solution for adhering and securing exercise equipment to smooth floor surfaces that does not require any special skills, tools, machinery or added cost. The present invention also allows exercise equipment products to be quickly and easily unadhered from smooth floor surfaces for moving or storage.

### BRIEF SUMMARY OF THE INVENTION

Most exercise equipment products are operated on smooth floor surfaces such as concrete, tile, hardwood, rubber covered concrete, and other smooth floor surfaces. The present invention creates a mechanical system for quickly, easily, and reversibly securing various exercise equipment products to these smooth floor surfaces with no tools, fasteners, or special skills required. In a preferred embodiment, a plurality of lockable suction cups are coupled to a first planar portion of the structural frame of an exercise equipment product such that the lockable suction cups contact the floor surface and support the exercise equipment product in the operational position. Each lockable suction cup comprises a locking actuator that can be manually actuated to a locked position so as to adhere and secure the base of the exercise equipment product to a smooth floor surface when the exercise equipment product is in an operational position. One or more lockable suction cups may also be coupled to a second planar portion of the exercise equipment product structural frame such that when the exercise equipment product is tilted or reoriented to a storage position, the lockable suction cups will contact the floor and support the exercise product in a storage position.

Each lockable suction cup that supports the storage position of the exercise equipment product comprises a lockable actuator that can be manually actuated to a locked position so as to adhere and secure the second planar portion of the exercise equipment product to a smooth floor surface when the exercise equipment product is in a storage position. Conversely, the lockable suction cups actuators can be manually actuated to the unlocked position to release the exercise equipment product from being adhered to the smooth floor surface in the operational or storage position such that the exercise equipment product can be moved to a different position or location.

The lockable suction cups can be used to adhere and secure virtually any type of exercise equipment product to a smooth floor surface including all cardiovascular training equipment products and strength training equipment products.

The present invention creates a mechanical system that allows a user to quickly and easily adhere exercise equipment products to a floor surface or release the product from the floor surface in both the operational and storage positions. This provides added safety for the user and bystanders as well as stabilized function during operation of the products, thus providing a very useful and novel improvement to all exercise equipment products.

### BRIEF DESCRIPTION OF THE DRAWINGS

FIG. 1 is a view of prior art illustrating a leg extension machine secured to a floor surface with a bolt fastener.

FIG. 2 is a side view of a lockable suction cup of the invention in the locked position and the unlocked position.

FIG. 3 is a side view of the invention comprising a ladder climber exercise equipment product in the operational position and secured to a smooth floor surface with locked suction cups while a user is mounted on and engaging the product. Also illustrated is a magnified view of a lockable suction cup with the locking actuator in the locked position.

FIG. 4 is a perspective view of the invention comprising a treadmill exercise equipment product in the operational position and secured to a smooth floor surface with locked suction cups.

FIG. 5 is a perspective view of the invention comprising a leg extension exercise equipment product in the operational position and secured to a smooth floor surface with locked suction cups.

FIG. 6 is a perspective view of the invention comprising a multi-station gym exercise equipment product in the operational position and secured to a smooth floor surface with locked suction cups.

FIG. 7 is a perspective view of the invention comprising a rower exercise equipment product in the operational position and secured to a smooth floor surface with locked suction cups.

FIG. 8 is a perspective view of the invention comprising a rower exercise equipment product in the storage position and secured to a smooth floor surface with locked suction cups.

FIG. 9 is a perspective view of the invention comprising a stationary bike exercise equipment product in the operational position and secured to a smooth floor surface with locked suction cups.

FIG. 10 is a perspective view of the invention comprising an elliptical strider exercise equipment product in the operational position and secured to a smooth floor surface with locked suction cups.

FIG. 11 is a perspective view of the invention comprising a sit up bench exercise equipment product in the operational position and secured to a smooth floor surface with locked suction cups while a user is mounted on and engaging the product.

FIG. 12 is a perspective view of the invention comprising a stair climber exercise equipment product in the operational position and secured to a smooth floor surface with locked suction cups.

FIG. 13 is a perspective view of the invention comprising a barbell rack exercise equipment product in the operational position and secured to a smooth floor surface with locked suction cups.

FIG. 14 is a perspective view of the invention comprising a triceps pushdown exercise equipment product in the operational position and secured to a smooth floor surface with locked suction cups while a user is engaging the product while standing on the smooth floor surface.

### DETAILED DESCRIPTION OF PREFERRED EMBODIMENTS

Exemplary preferred embodiments are disclosed below in connection with the attached drawings. Throughout this specification, various terms will be used to describe various components or features of the invention. For example, the term “exercise equipment” or “exercise equipment product” or “product” will refer to any machine, bench, rack, or other exercise apparatus that a user can engage while performing a physical fitness or therapeutic exercise motion that can be integrated into the invention and adhered and secured to a smooth floor surface. The term “structural frame” or “frame” will refer to the primary structural component or components of an exercise equipment product. The term “planar” or “planar portion” will refer to a geometric plane related to the structure of an exercise equipment product that can become parallel to a floor surface. The term “forward end” will refer to the end of an exercise equipment product that a user would face when operating an exercise equipment product. The term “rearward end” will refer to the end of an exercise equipment product that would be opposite the end a user would face when operating an exercise equipment product. The term “actuator” will refer to an actuator, switch, or the like that can engage or disengage a mechanical feature of a product or component. For reference numerals with letter character designations such as “13A” or “13B”, the letter character designations may differentiate two like parts or elements present in the same figure, or the same part in different positions or orientations. Letter character designations for reference numerals may be omitted when it is intended that a reference numeral to encompass all parts having the same reference numeral in all figures.

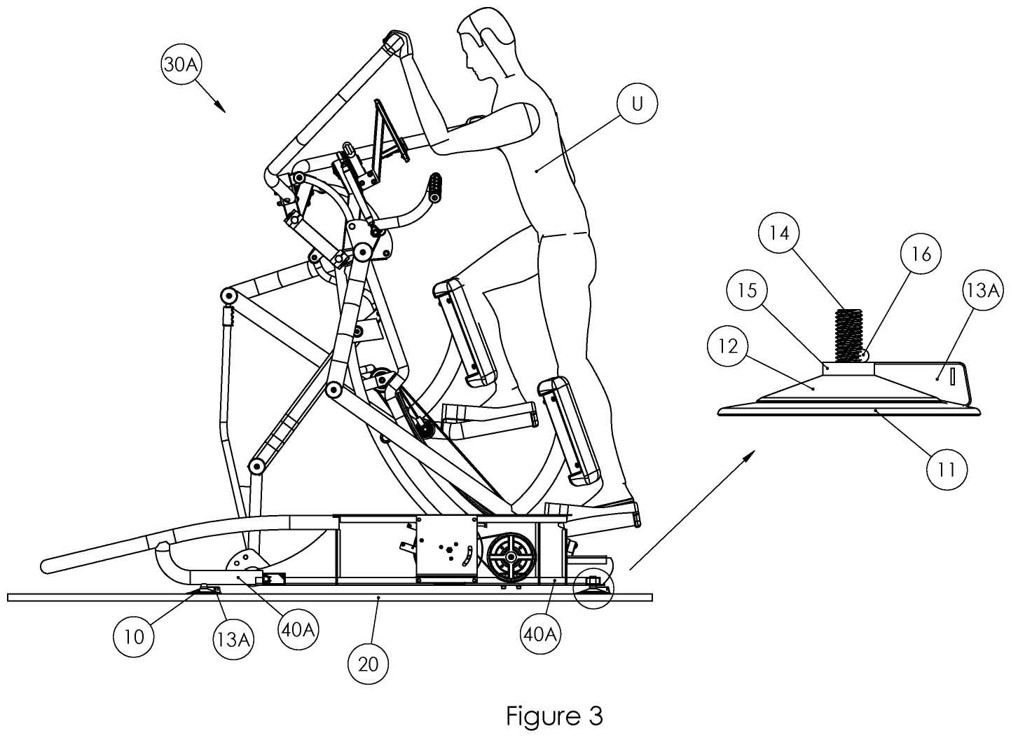

FIGS. 3-14 are all views of preferred embodiments of the invention this inventor terms “A mechanical system for securing exercise equipment to a smooth floor surface utilizing lockable suction cups”. Generally, the invention is a system that is integrated into an exercise equipment product to releasably secure the product to a smooth floor surface while the product is in an operational or stored position. The lockable suction cups create a system that greatly improves the safety and stability of exercise equipment products by allowing a user to easily engage the mechanical system or disengage the mechanical system. This is a substantial improvement over the previous method of securing an exercise equipment product to a floor surface which requires a user to fasten an exercise equipment product to a floor surface with bolts or screws, which is simply too challenging or undesirable to do such that the safety of the usage and storage of most exercise equipment products are compromised. Although various types and categories of exercise equipment products are illustrated in FIGS. 3-14, it is to be expressly understood that this mechanical system invention can be utilized to secure any type of exercise equipment product to a smooth floor surface that is intended to be operated while resting on a floor surface.

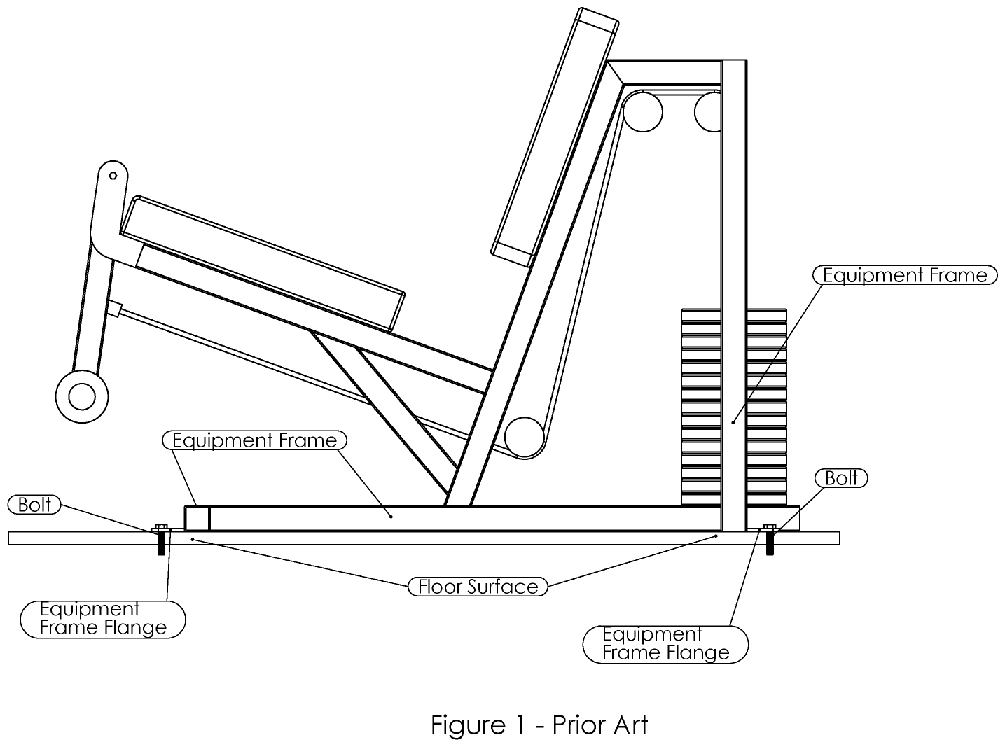

FIG. 1, illustrates a prior art method for securing exercise equipment products to a floor surface. In this illustration, an equipment frame flange is rigidly connected to the equipment frame in contact or close proximity to the floor surface. The equipment frame flange comprises a through hole. The owner of this equipment is required to place a fastener through the through hole and into the floor surface to secure the product to the floor. The through hole could also be within the equipment frame itself, which in this case is made of square tubing and achieve the same results.

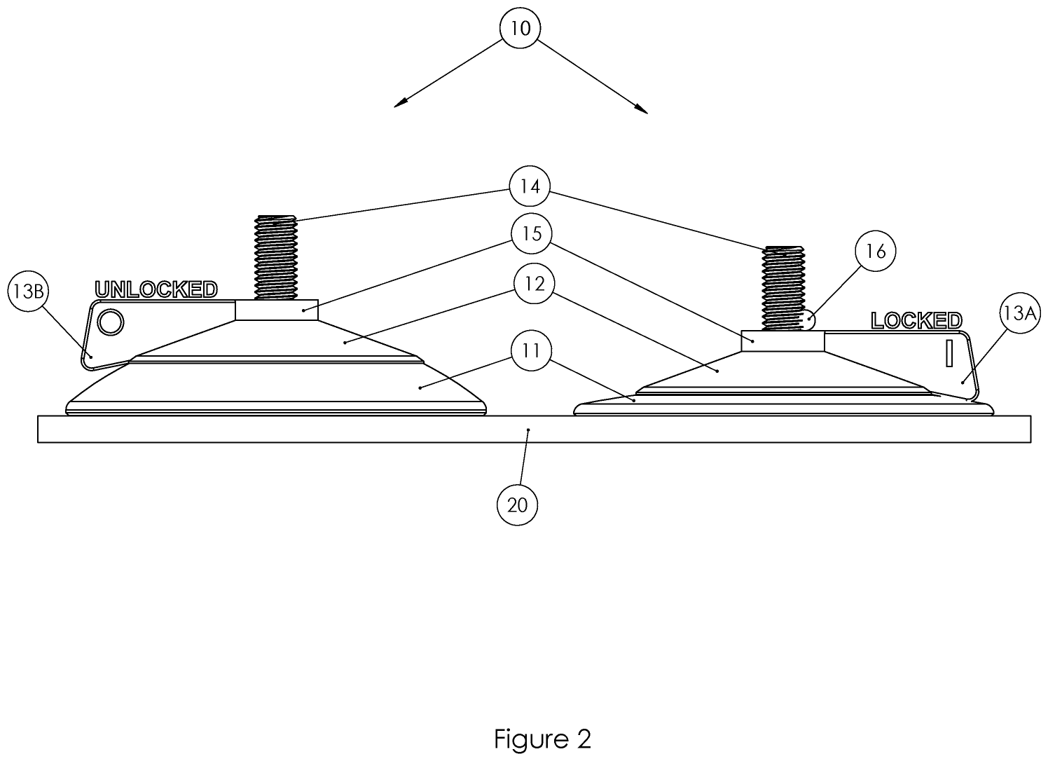

FIG. 2 illustrates a lockable suction cup 10 comprising a threaded stem 14, a plunger 12, a flexible membrane 11, a locking actuator 13, a locking nut 15, and a detent ball 16. Threaded stem 14 is the component that couples lockable suction cup 10 to an exercise equipment product. Locking nut 15 is engaged with threaded stem 14 and actuator 13 (illustrated in a locked position 13A and in an unlocked position 13B) is a rigid component that is rigidly attached to locking nut 15. Detent ball 16 is spring loaded and operatively mounted within threaded stem 14. Plunger 12 is a rigid or semi-rigid component that is captured on treaded stem 14 and moves vertically along threaded stem 14. Flexible membrane 11 is engaged with plunger 12 and flexible membrane 11 has a spring like memory shape that causes flexible membrane 11 to remain in a contracted, higher angle position when not urged to a different shape and position.

When in the unlocked position, lockable suction cup 10 is resting on a smooth floor surface 20 and locking actuator 13 is in the unlocked position 13B and locking nut 15 is in a higher position on threaded stem 14 and detent ball 16 is trapped by locking nut 15 within treaded stem 14. When locking actuator 13 is in the unlocked position 13B, plunger 12 is at a higher position on threaded stem 14 and flexible membrane 11 is in a higher more contracted position such that the outside diameter of flexible membrane 11 is smaller and has less contact with smooth floor surface 20.

To activate lockable suction cup 10 from the unlocked position to the locked position, locking actuator 13 moves from the unlocked position 13B to the locked position 13A causing locking nut 15 to rotate on threaded stem 14 and move downward on threaded stem 14 causing plunger 12 to move downward and compress flexible membrane 11 to a lower more extended configuration that creates a larger outside diameter and has more contact with smooth floor surface 20. This lowering and spreading motion of flexible membrane 11 creates a suction between flexible membrane 11 and smooth floor surface 20, thus adhering lockable suction cup 10 to floor surface 20. When locking actuator 13 is moved to the locked position 13A, this moves locking nut 15 below detent ball 16 such that a portion of detent ball 16 extends from treaded stem 14 and detains locking actuator 13 in the locked position 13A thus causing plunger 12 and membrane 11 to remain in their lower most positions.

To deactivate lockable suction cup 10 from the locked position 13A to the unlocked position 13B, locking actuator 13 is moved from the locked position 13A with sufficient force such that locking nut 15 compresses detent ball 16 into treaded stem 14. As locking actuator 13 moves from the locked position 13A to the unlocked position 13B, the locking nut 15 moves upward on treaded stem 14 causing plunger 12 to move upward on threaded stem 14 causing flexible membrane 11 to contract and release the suction between flexible membrane 11 and smooth floor surface 20.

While lockable suction cup 10 in FIG. 2 has been described with certain components that function in a certain manner, it is to be expressly understood that the components and or configuration of certain components could be changed or modified and achieve the same or nearly identical function. For example, locking actuator 13 could be replaced with a different type of actuator or switch that could move and lock plunger 12 and flexible membrane 11 with the same or nearly identical function. Another example is that threaded stem 14 could be replaced with a different component for coupling suction cup 10 to an exercise equipment product and achieve the same or nearly identical function.

FIGS. 3-14 illustrate various exercise equipment products utilizing lockable suction cups 10 to releasably adhere and secure these exercise equipment products to a smooth floor surface 20.

FIG. 3 illustrates a user U mounted on and engaging a ladder climber exercise equipment product 30A while ladder climber exercise equipment product 30A is in the operational position. This is a side view that illustrates the left side of ladder climber exercise equipment product 30A that is coupled to forward and rearward lockable suction cups 10 that support ladder climbing exercise equipment product 30A on smooth floor surface 20 and locking actuators 13 are in the locked position 13A so as to adhere and secure ladder climber exercise equipment product 30A to smooth floor surface 20. Lockable suction cups 10 are coupled to ladder climber exercise equipment product 30A with ladder climber structural frame 40A. The right side components of ladder climbing exercise equipment product 30A are a mirror image of the left side components utilizing an identical right side set of components as described herein. For clarity, a lockable suction cup 10 is illustrated in a magnified view. Lockable suction cups 10 can be unlocked as previously described herein such that ladder climber exercise equipment product 30A can be moved to a different position or location.

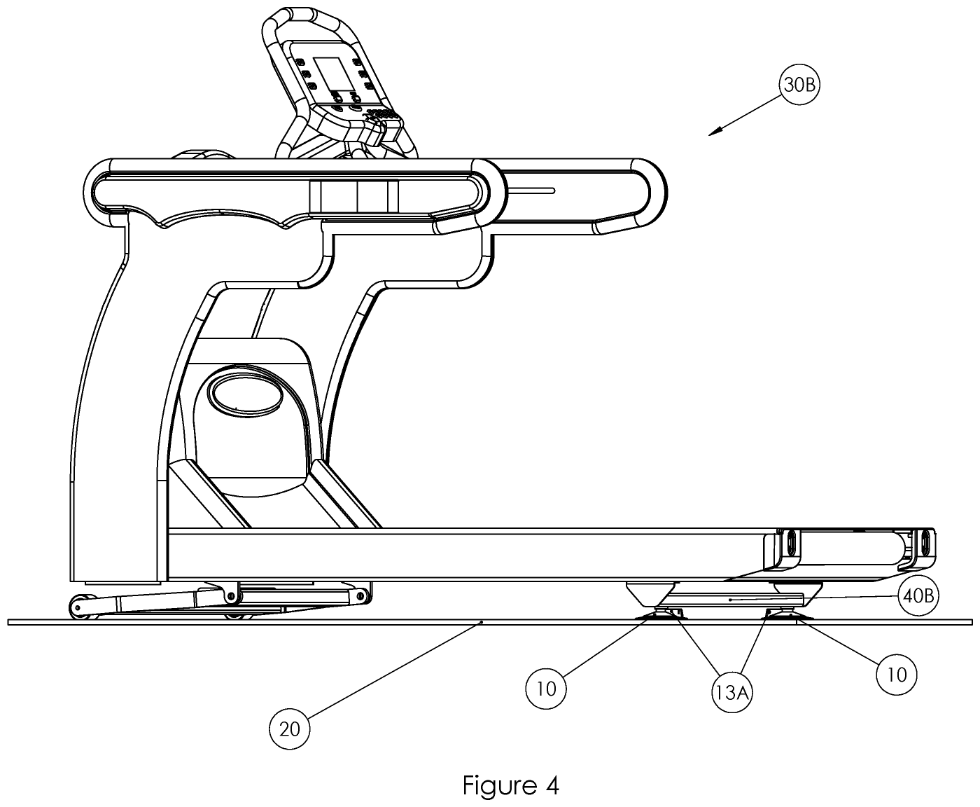

FIG. 4 illustrates a treadmill exercise equipment product 30B in the operational position. This is an example of an exercise equipment product wherein only a portion of the product can be coupled to lockable suction cups 10 for adhering and securing the product to a smooth floor surface 20. In this example, only the rearward portion of treadmill exercise equipment product 30B is supported by left and right lockable suction cups 10 on smooth floor surface 20 as the forward portion of treadmill exercise equipment product 30B raises and lowers during operation of treadmill exercise equipment product 30B. Lockable suction cups 10 are coupled to the rearward portion of treadmill exercise equipment product 30B with treadmill structural frame 40B. Lockable suction cups 10 are in the locked position as indicated by the locking actuator 13 being in the locked position 13A so as to adhere and secure the rearward portion of treadmill exercise equipment product 30B to smooth floor surface 20. Lockable suction cups 10 can be unlocked as previously described herein such that treadmill exercise equipment product 30B can be moved to a different position or location.

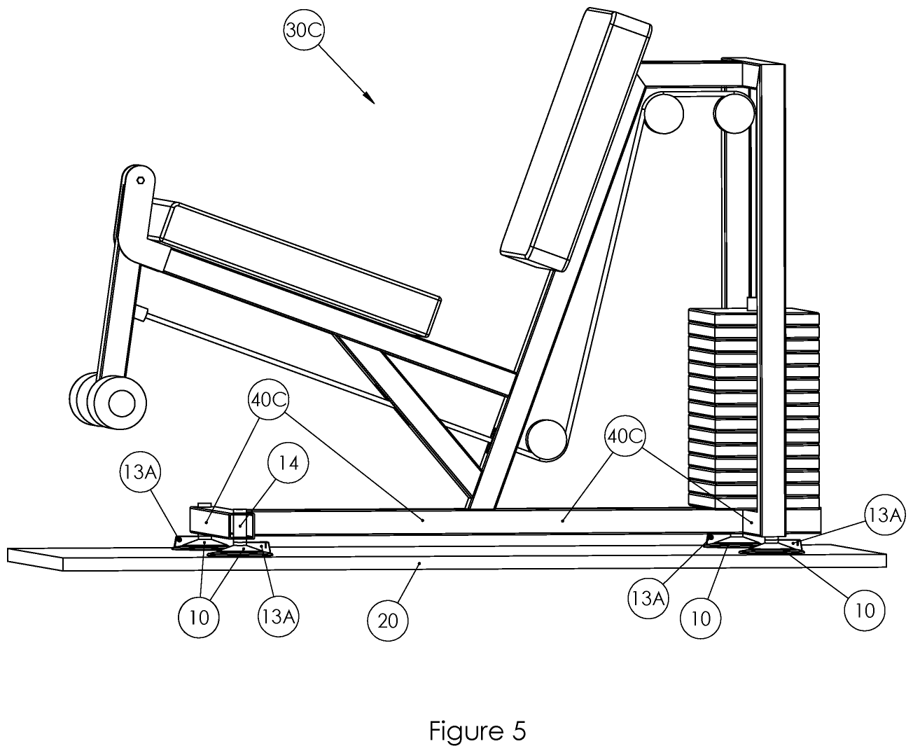

FIG. 5 illustrates a leg extension exercise equipment product 30C in the operational position. In this example, four lockable suction cups 10 support leg extension exercise equipment product 30C on smooth floor surface 20 and lockable suction cups 10 are coupled to leg extension exercise equipment product 30C with leg extension structural frame 40C. Lockable suction cups 10 are in the locked position as indicated by locking actuator 13 being in the locked position 13A so as to adhere and secure leg extension exercise equipment product 30C to smooth floor surface 20. Lockable suction cups 10 can be unlocked as previously described herein such that leg extension exercise equipment product 30C can be moved to a different position or location.

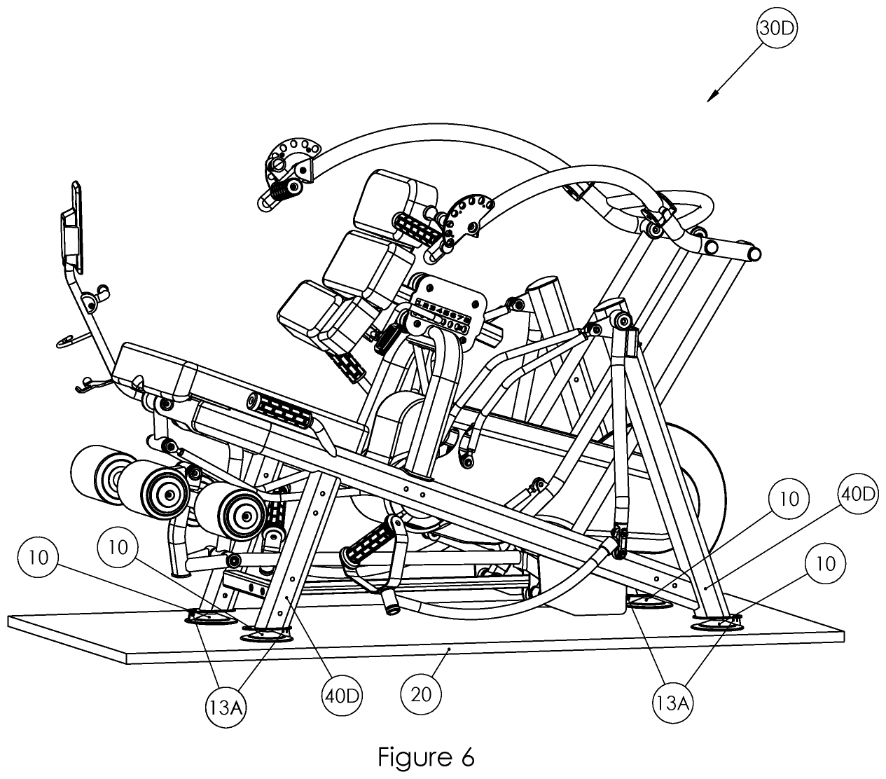

FIG. 6 illustrates a multi-station gym exercise equipment product 30D in the operational position. In this example, four lockable suction cups 10 support multi-station gym exercise equipment product 30D on smooth floor surface 20 and lockable suction cups 10 are coupled to multi-station gym exercise equipment product 30D with multi-station gym structural frame 40D. Lockable suction cups 10 are in the locked position as indicated by locking actuator 13 being in the locked position 13A so as to adhere and secure multi-station gym exercise equipment product 30D to smooth floor surface 20. Lockable suction cups 10 can be unlocked as previously described herein such that multi-station gym exercise equipment product 30D can be moved to a different position or location.

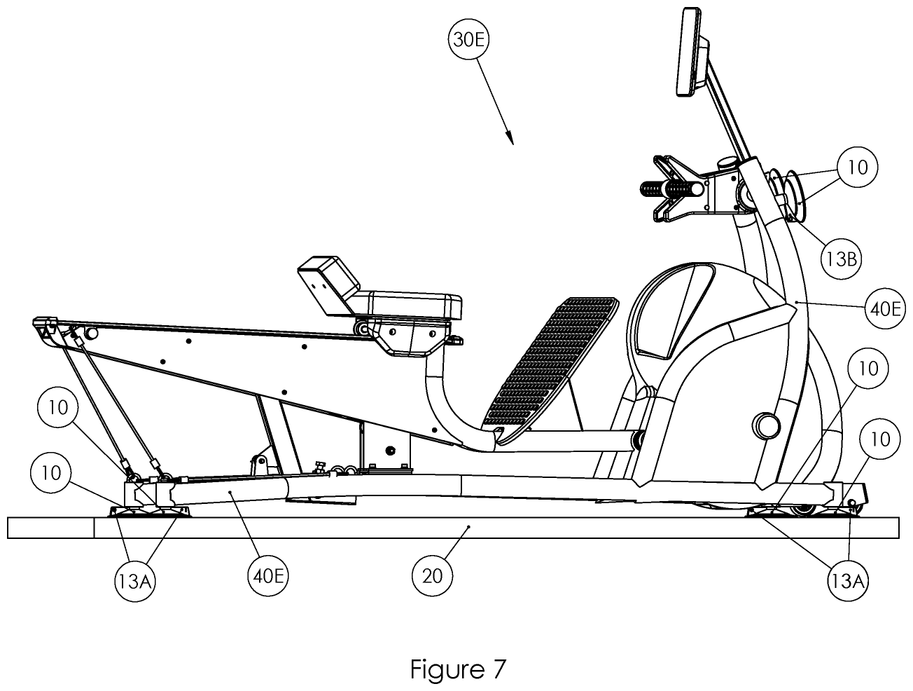

FIG. 7 illustrates a rower exercise equipment product 30E in the operational position. In this example, four lockable suction cups 10 support rower exercise equipment product 30E on smooth floor surface 20 and these four lockable suction cups 10 are coupled to rower exercise equipment product 30E with rower structural frame 40E at a lower portion of rower structural frame 40E. The four lockable suction cups 10 contacting smooth floor surface 20 are in the locked position as indicated by locking actuator 13 being in the locked position 13A so as to adhere and secure rower exercise equipment product 30E to smooth floor surface 20. Two additional lockable suction cups 10 are coupled to an upper portion of rower structural frame 40E and are in the unlocked position as indicated by locking actuator 13 being in the unlocked position 13B. The four lockable suction cups 10 that are coupled to a lower portion of rower structural frame 40E and contacting smooth floor surface 20 can be unlocked as previously described herein such that rower exercise equipment product 30E can be moved to a different position or location.

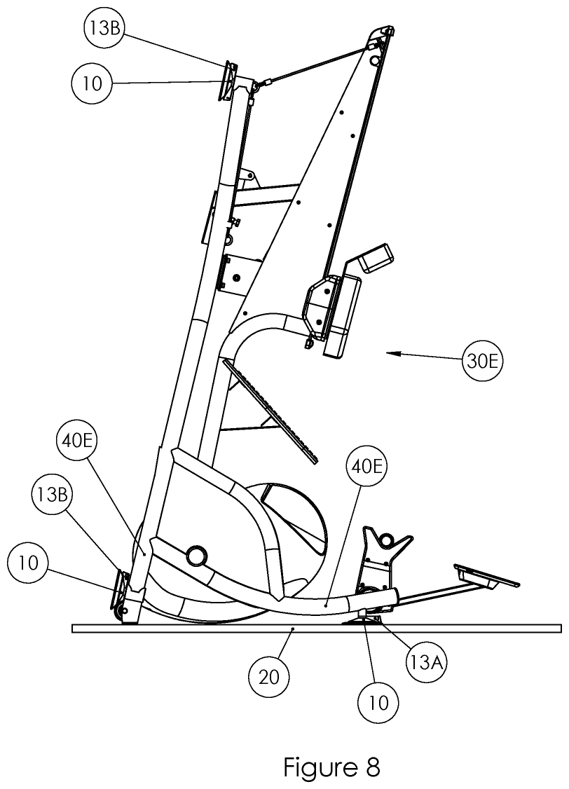

FIG. 8 illustrates a side view of a rower exercise equipment product 30E in the storage position. A right side lockable suction cup 10 is partially supporting rower exercise equipment product 30E on smooth floor surface 20 and is in the locked position as indicated by locking actuator 13 being in the locked position 13A so as to adhere and secure rower exercise equipment product 30E to smooth floor surface 20. Although not shown in this view, an identical left side lockable suction cup 10 also partially supports rower exercise equipment product 30E in the storage position on smooth flooring surface 20 and is in the locked position. Right side forward and rearward lockable suction cups 10 that are not contacting smooth floor surface 20 are in the unlocked position as indicated by locking actuator 13 being in the unlocked position 13B. Although not shown in this view, an identical left side forward and rearward lockable suction cups 10 that are not contacting smooth floor surface 20 are in the unlocked position. All suction cups 10 are coupled to rower exercise equipment product 30E with rower structural frame 40E. The two lockable suction cups 10 that are contacting smooth floor surface 20 can be unlocked as previously described herein such that rower exercise equipment product 30E can be moved to a different position or location.

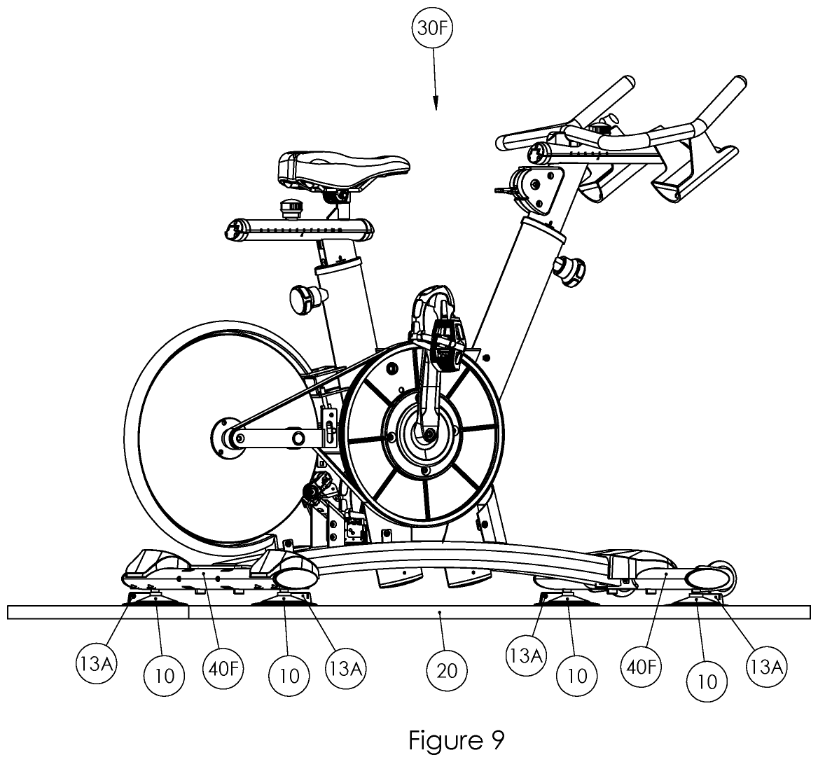

FIG. 9 illustrates a stationary bike exercise equipment product 30F in the operational position. In this example, four lockable suction cups 10 support stationary bike exercise equipment product 30F on smooth floor surface 20 and lockable suction cups 10 are coupled to stationary bike exercise equipment product 30F with stationary bike structural frame 40F. Lockable suction cups 10 are in the locked position as indicated by locking actuators 13 being in the locked position 13A so as to adhere and secure stationary bike exercise equipment product 30F to smooth floor surface 20. Lockable suction cups 10 can be unlocked as previously described herein such that stationary bike exercise equipment product 30F can be moved to a different position or location.

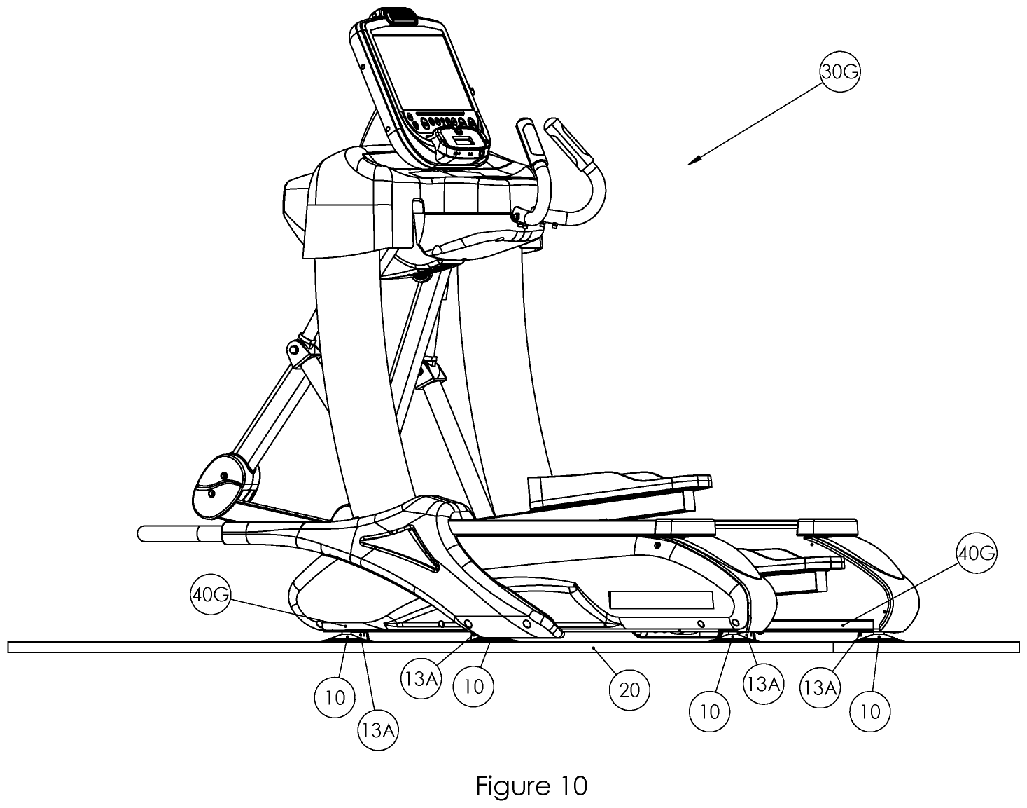

FIG. 10 illustrates an elliptical strider exercise equipment product 30G in the operational position. In this example, four lockable suction cups 10 support elliptical strider exercise equipment product 30G on smooth floor surface 20 and lockable suction cups 10 are coupled to elliptical strider exercise equipment product 30G with elliptical strider structural frame 40G. Lockable suction cups 10 are in the locked position as indicated by locking actuators 13 being in the locked position 13A so as to adhere and secure elliptical strider exercise equipment product 30G to smooth floor surface 20. Lockable suction cups 10 can be unlocked as previously described herein such that elliptical strider exercise equipment product 30G can be moved to a different position or location.

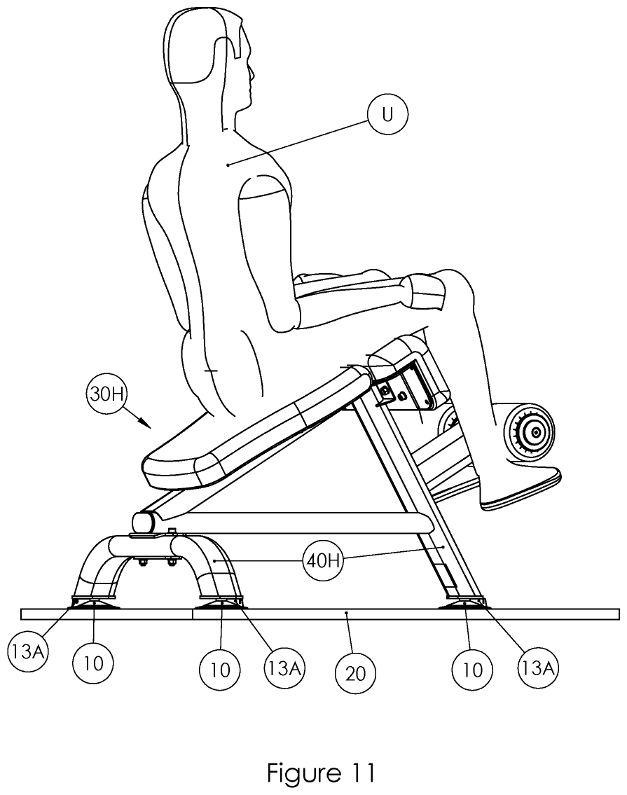

FIG. 11 illustrates a user U mounted on and engaging a sit up bench exercise equipment product 30H while sit up bench exercise equipment product 30H is in the operational position. In this example, three lockable suction cups 10 support sit up bench exercise equipment product 30H on smooth floor surface 20 and lockable suction cups 10 are coupled to sit up bench exercise equipment product 30H with sit up bench structural frame 40H. Lockable suction cups 10 are in the locked position as indicated by locking actuator 13 being in the locked position 13A so as to adhere and secure sit up bench exercise equipment product 30H to smooth floor surface 20. Lockable suction cups 10 can be unlocked as previously described herein such that leg extension exercise equipment product 30H can be moved to a different position or location.

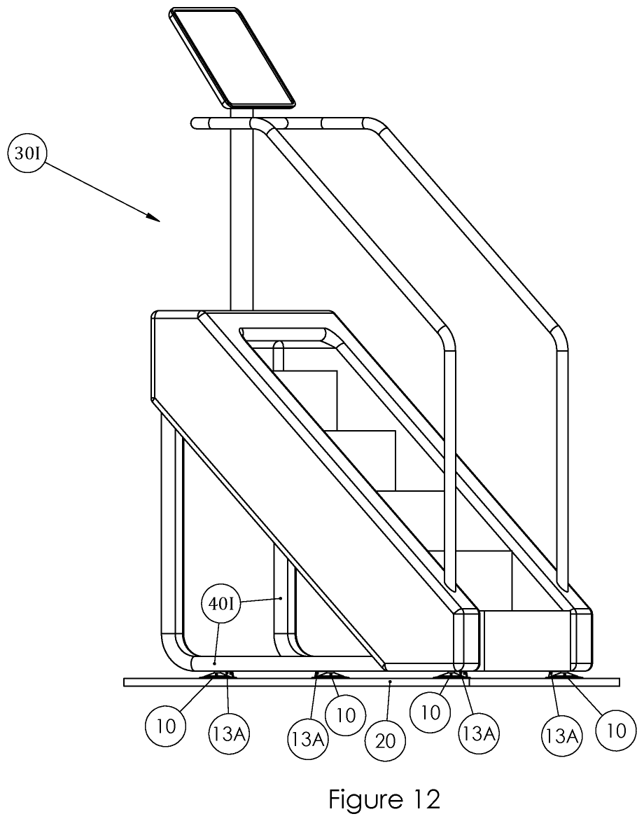

FIG. 12 illustrates a stair climber exercise equipment product 30I in the operational position. In this example, four lockable suction cups 10 support stair climber exercise equipment product 30I on smooth floor surface 20 and lockable suction cups 10 are coupled to stair climber exercise equipment product 30I with stair climber structural frame 40I. Lockable suction cups 10 are in the locked position as indicated by locking actuator 13 being in the locked position 13A so as to adhere and secure stair climber exercise equipment product 30I to smooth floor surface 20. Lockable suction cups 10 can be unlocked as previously described herein such that stair climbing exercise equipment product 30I can be moved to a different position or location.

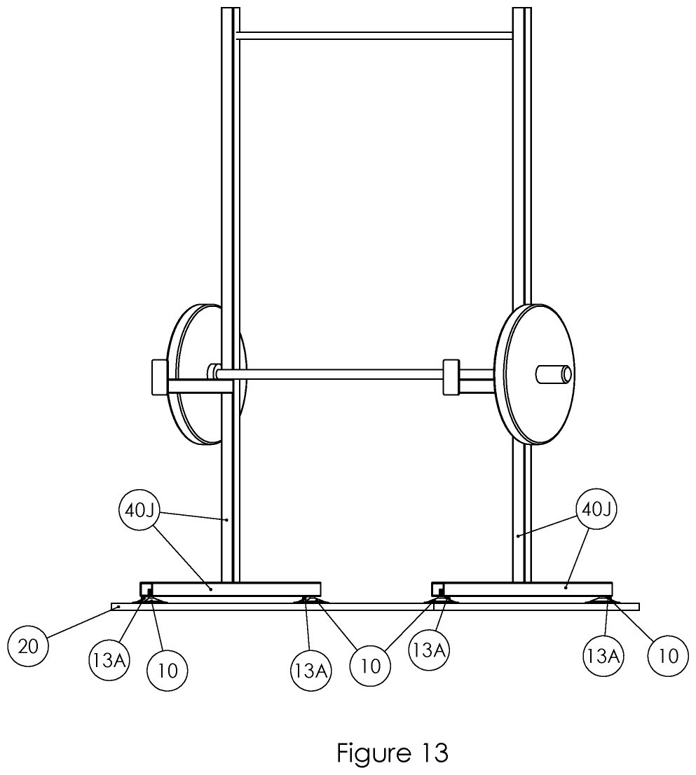

FIG. 13 illustrates a barbell rack exercise equipment product 30J in the operational position. In this example, four lockable suction cups 10 support barbell rack exercise equipment product 30J on smooth floor surface 20 and lockable suction cups 10 are coupled to barbell rack exercise equipment product 30J with barbell rack structural frame 40J. Lockable suction cups 10 are in the locked position as indicated by locking actuator 13 being in the locked position 13A so as to adhere and secure stair climbing exercise equipment product 30J to smooth floor surface 20. Lockable suction cups 10 can be unlocked as previously described herein such that barbell rack exercise equipment product 30J can be moved to a different position or location.

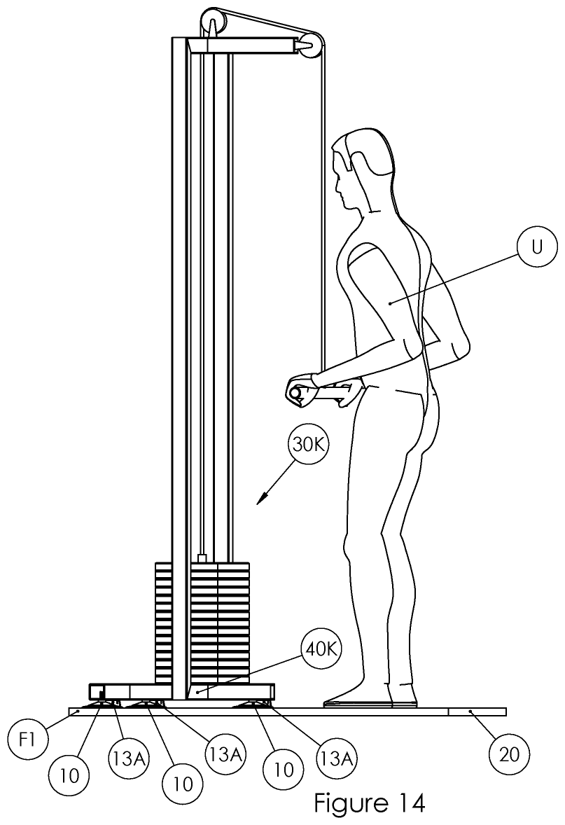

FIG. 14 illustrates a user U standing on smooth floor surface 20 and engaging a triceps pushdown exercise equipment product 30K while triceps pushdown exercise equipment product 30K is in the operational position. In this example, three lockable suction cups 10 support triceps pushdown exercise equipment product 30K on smooth floor surface 20 and lockable suction cups 10 are coupled to triceps pushdown exercise equipment product 30K with triceps pushdown structural frame 40K. Lockable suction cups 10 are in the locked position as indicated by locking actuator 13 being in the locked position 13A so as to adhere and secure triceps pushdown exercise equipment product 30K to smooth floor surface 20. Lockable suction cups 10 can be unlocked as previously described herein such that triceps pushdown exercise equipment product 30K can be moved to a different position or location.

One preferred embodiment of the mechanical system for securing exercise equipment to a smooth floor surface utilizing lockable suction cups comprises (a) an exercise equipment product comprising a structural frame; (b) at least one lockable suction cup coupled to a first planar portion of the structural frame wherein the at least one lockable suction cup contacts a smooth floor surface and supports at least a portion of the exercise equipment product on the smooth floor surface when the first planar portion of the exercise equipment product is parallel to the smooth floor surface and the exercise equipment product is in an operational position; and (c) a locking actuator on each of the at least one lockable suction cup that is actuatable between an unlocked position and a locked position causing the at least one lockable suction cup to create a suction against the smooth floor surface in the locked position, thereby causing at least a portion of the exercise equipment product to be adhered to the smooth floor surface.

In this mechanical system, the at least one lockable suction cup can comprise a flexible membrane that expands to create a suction against the smooth floor surface when the locking actuator is actuated to the locked position and that contracts and releases the suction against the smooth floor surface when the locking actuator is actuated to the unlocked position.

In this mechanical system, the at least one lockable suction cup can be coupled to a second planer portion of the structural frame of the exercise equipment product, wherein the at least one lockable suction cup can contact the floor surface to support at least a portion of the exercise equipment product when the second planar portion of the structural frame of the exercise machine product is parallel to the smooth floor surface and the exercise equipment product is in a storage position, and wherein the at least one lockable suction cup can adhere the exercise equipment product to the smooth floor surface when the locking actuator is in the locked position.

In this mechanical system, the exercise equipment product can be placed in a desired location in the operational position and the locking actuator can be actuated to the locked position so as to adhere the exercise equipment product to the smooth floor surface.

In this mechanical system, the locking actuator can be actuated to the unlocked position so as to unadhered the exercise equipment product from the smooth floor surface.

Another preferred embodiment of the mechanical system for securing exercise equipment to a smooth floor surface utilizing lockable suction cups comprises (a) an exercise equipment product comprising a structural frame; (b) at least two lockable suction cups coupled to a first planar portion of the structural frame wherein the at least two lockable suction cups each contact a smooth floor surface and support at least a portion of the exercise equipment product on the smooth floor surface when the first planar portion of the exercise equipment product is parallel to the smooth floor surface and the exercise equipment product is in an operational position, the at least two lockable suction cups being located a distance apart from each other on the first planar portion of the structural frame; and (c) a locking actuator on each of the at least two lockable suction cups that is actuatable between an unlocked position and a locked position causing the at least two lockable suction cups to create a suction against the smooth floor surface in the locked position, thereby causing at least a portion of the exercise equipment product to be adhered to the smooth floor surface.

In this mechanical system, the at least two lockable suction cups each can comprise a flexible membrane that expands to create a suction against the smooth floor surface when the locking actuator is actuated to the locked position and that contracts and releases the suction against the smooth floor surface when the locking actuator is actuated to the unlocked position.

This mechanical system can further comprise at least a third lockable suction cup that is coupled to a second planer portion of the structural frame of the exercise equipment product, wherein the at least a third lockable suction cup can contact the floor surface to support at least a portion of the exercise equipment product when the second planar portion of the structural frame of the exercise machine product is parallel to the smooth floor surface and the exercise equipment product is in a storage position, and wherein the at least a third lockable suction cup can adhere the exercise equipment product to the smooth floor surface when the locking actuator is in the locked position.

Another preferred embodiment of the mechanical system for securing exercise equipment to a smooth floor surface utilizing lockable suction cups comprises (a) an exercise equipment product comprising a structural frame; (b) at least three lockable suction cups, wherein at least two of the at least three lockable suction cups are coupled to a first planar portion of the structural frame wherein the at least two lockable suction cups each contact a smooth floor surface and support at least a portion of the exercise equipment product on the smooth floor surface when the first planar portion of the exercise equipment product is parallel to the smooth floor surface and the exercise equipment product is in an operational position, the at least two lockable suction cups being located a distance apart from each other on the first planar portion of the structural frame, and wherein a third of the at least three lockable suction cups is coupled to a second planer portion of the structural frame of the exercise equipment product, wherein the third lockable suction cup contacts the floor surface to support at least a portion of the exercise equipment product when the second planar portion of the structural frame of the exercise machine product is parallel to the smooth floor surface and the exercise equipment product is in a storage position; and (c) a locking actuator on each of the at least three lockable suction cups that is actuatable between an unlocked position and a locked position causing the at least two lockable suction cups on the first planar portion of the exercise equipment product to create a suction against the smooth floor surface in the locked position, thereby causing at least a portion of the exercise equipment product to be adhered to the smooth floor surface when the exercise equipment product in in the operational position, and causing the third lockable suction cup on the second planar portion of the exercise equipment product to create a suction against the smooth floor surface in the locked position, thereby causing at least a portion of the exercise equipment product to be adhered to the smooth floor surface when the exercise equipment product in in the storage position.

In this mechanical system, the at least two lockable suction cups each can comprise a flexible membrane that expands to create a suction against the smooth floor surface when the locking actuator is actuated to the locked position and that contracts and releases the suction against the smooth floor surface when the locking actuator is actuated to the unlocked position.

In each of the preferred embodiments of the mechanical system, the exercise equipment product can be selected from the group consisting of stationary bicycles, elliptical exercise machines, stair climbing machines, ladder climbing machines, treadmills, rowing machines, body weight resisted benches and racks, multi-function exercise machines, benches and racks that support barbells, weight stack resisted exercise machines, flywheel resisted exercise machines, pneumatically resisted exercise machines, magnetically resisted exercise machines, fluid resisted exercise machines, spring resisted exercise machines, cable resistance exercise machines, belt resistance machines, tire flipping machines, and boxing simulators.

In each of the preferred embodiments of the mechanical system, the locking actuator can comprise a lever, switch, button, or pin for actuating the locking actuator.

In each of the preferred embodiments of the mechanical system, the exercise equipment product can further comprise a user support such that the user is mounted on and supported by the exercise equipment product via the user support when the user is operating or engaging the exercise equipment product. Alternatively, the exercise equipment product does not need to comprise a user support such that the user is supported by the smooth floor surface when the user is operating or engaging the exercise equipment product.

Features and components of the preferred embodiment of the present invention include at least two lockable suction cups each comprising a locking actuator, an exercise equipment product comprising a structural frame and a smooth floor surface, wherein the lockable suction cups are coupled to the exercise equipment structural frame such that the lockable suction cups support the exercise equipment product on the smooth floor surface and the lockable suction cups can be releasably adhered and locked to the smooth floor surface therefore adhering and securing the exercise equipment product to the smooth floor surface.

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims.

### REFERENCE NUMERALS

10 Lockable suction cup
11 Flexible membrane
12 Plunger
13 Locking actuator
13A Locking actuator in the locked position
13B Locking actuator in the unlocked position
14 Threaded stem
15 Locking nut
16 Detent ball
20 Smooth floor surface
30 Exercise equipment product
30A Ladder climber exercise equipment product
30B Treadmill exercise equipment product
30C Leg extension exercise equipment product
30D Multi-station gym exercise equipment product
30E Rower exercise equipment product
30F Stationary bike exercise equipment product
30G Elliptical strider exercise equipment product
30H Sit up bench exercise equipment product
30I Stair climber exercise equipment product
30J Barbell rack exercise equipment product
30K Triceps press down exercise equipment product
40 Structural frame
40A Ladder climber structural frame
40B Treadmill structural frame
40C Leg extension structural frame
40D Multi-station gym structural frame
40E Rower structural frame
40F Stationary bike structural frame
40G Elliptical strider structural frame
40H Sit up bench structural frame
40I Stair climber structural frame
40J Barbell rack structural frame
40K Triceps press down structural frame
U User

What is claimed is:

1. A mechanical system for securing exercise equipment to a smooth floor surface utilizing lockable suction cups comprising:
a) an exercise equipment product comprising a structural frame;
b) at least one lockable suction cup coupled to a first planar portion of the structural frame wherein the at least one lockable suction cup contacts a smooth floor surface and supports at least a portion of the exercise equipment product on the smooth floor surface when the first planar portion of the exercise equipment product is parallel to the smooth floor surface and the exercise equipment product is in an operational position; and
c) a locking actuator on each of the at least one lockable suction cup that is actuatable between an unlocked position and a locked position causing the at least one lockable suction cup to create a suction against the smooth floor surface in the locked position, thereby causing at least a portion of the exercise equipment product to be adhered to the smooth floor surface.

2. The mechanical system of claim 1, wherein the locking actuator comprises a lever, switch, button, or pin for actuating the locking actuator.

3. The mechanical system of claim 2, wherein the at least one lockable suction cup comprises a flexible membrane that expands to create a suction against the smooth floor surface when the locking actuator is actuated to the locked position and that contracts and releases the suction against the smooth floor surface when the locking actuator is actuated to the unlocked position.

4. The mechanical system of claim 3, wherein the exercise equipment product is selected from the group consisting of stationary bicycles, elliptical exercise machines, stair climbing machines, ladder climbing machines, treadmills, rowing machines, body weight resisted benches and racks, multi-function exercise machines, benches and racks that support barbells, weight stack resisted exercise machines, flywheel resisted exercise machines, pneumatically resisted exercise machines, magnetically resisted exercise machines, fluid resisted exercise machines, spring resisted exercise machines, cable resistance exercise machines, belt resistance machines, tire flipping machines, and boxing simulators.

5. The mechanical system of claim 3, wherein the at least one lockable suction cup is coupled to a second planer portion of the structural frame of the exercise equipment product, wherein the at least one lockable suction cup contacts the floor surface to support at least a portion of the exercise equipment product when the second planar portion of the structural frame of the exercise machine product is parallel to the smooth floor surface and the exercise equipment product is in a storage position, and wherein the at least one lockable suction cup adheres the exercise equipment product to the smooth floor surface when the locking actuator is in the locked position.

6. The mechanical system of claim 4, wherein the exercise equipment product further comprises a user support such that the user is mounted on and supported by the exercise equipment product via the user support when the user is operating or engaging the exercise equipment product.

7. The mechanical system of claim 4, wherein the exercise equipment product does not comprise a user support such that the user is supported by the smooth floor surface when the user is operating or engaging the exercise equipment product.

8. The mechanical system of claim 4, wherein the exercise equipment product is placed in a desired location in the operational position and the locking actuator is actuated to the locked position so as to adhere the exercise equipment product to the smooth floor surface.

9. The mechanical system of claim 4, wherein the locking actuator is actuated to the unlocked position so as to unadhered the exercise equipment product from the smooth floor surface.

10. A mechanical system for securing exercise equipment to a smooth floor surface utilizing lockable suction cups comprising:
a) an exercise equipment product comprising a structural frame;
b) at least two lockable suction cups coupled to a first planar portion of the structural frame wherein the at least two lockable suction cups each contact a smooth floor surface and support at least a portion of the exercise equipment product on the smooth floor surface when the first planar portion of the exercise equipment product is parallel to the smooth floor surface and the exercise equipment product is in an operational position, the at least two lockable suction cups being located a distance apart from each other on the first planar portion of the structural frame; and
c) a locking actuator on each of the at least two lockable suction cups that is actuatable between an unlocked position and a locked position causing the at least two lockable suction cups to create a suction against the smooth floor surface in the locked position, thereby causing at least a portion of the exercise equipment product to be adhered to the smooth floor surface.

11. The mechanical system of claim 10, wherein the locking actuator comprises a lever, switch, button, or pin for actuating the locking actuator.

12. The mechanical system of claim 11, wherein the at least two lockable suction cups each comprise a flexible membrane that expands to create a suction against the smooth floor surface when the locking actuator is actuated to the locked position and that contracts and releases the suction against the smooth floor surface when the locking actuator is actuated to the unlocked position.

13. The mechanical system of claim 12, wherein the exercise equipment product is selected from the group consisting of stationary bicycles, elliptical exercise machines, stair climbing machines, ladder climbing machines, treadmills, rowing machines, body weight resisted benches and racks, multi-function exercise machines, benches and racks that support barbells, weight stack resisted exercise machines, flywheel resisted exercise machines, pneumatically resisted exercise machines, magnetically resisted exercise machines, fluid resisted exercise machines, spring resisted exercise machines, cable resistance exercise machines, belt resistance machines, tire flipping machines, and boxing simulators.

14. The mechanical system of claim 12, further comprising at least a third lockable suction cup that is coupled to a second planer portion of the structural frame of the exercise equipment product, wherein the at least a third lockable suction cup contacts the floor surface to support at least a portion of the exercise equipment product when the second planar portion of the structural frame of the exercise machine product is parallel to the smooth floor surface and the exercise equipment product is in a storage position, and wherein the at least a third lockable suction cup adheres the exercise equipment product to the smooth floor surface when the locking actuator is in the locked position.

15. The mechanical system of claim 13, wherein the exercise equipment product further comprises a user support such that the user is mounted on and supported by the exercise equipment product via the user support when the user is operating or engaging the exercise equipment product.

16. The mechanical system of claim 13, wherein the exercise equipment product does not comprise a user support such that the user is supported by the smooth floor surface when the user is operating or engaging the exercise equipment product.

17. A mechanical system for securing exercise equipment to a smooth floor surface utilizing lockable suction cups comprising:
a) an exercise equipment product comprising a structural frame;
b) at least three lockable suction cups, wherein at least two of the at least three lockable suction cups are coupled to a first planar portion of the structural frame wherein the at least two lockable suction cups each contact a smooth floor surface and support at least a portion of the exercise equipment product on the smooth floor surface when the first planar portion of the exercise equipment product is parallel to the smooth floor surface and the exercise equipment product is in an operational position, the at least two lockable suction cups being located a distance apart from each other on the first planar portion of the structural frame, and wherein a third of the at least three lockable suction cups is coupled to a second planer portion of the structural frame of the exercise equipment product, wherein the third lockable suction cup contacts the floor surface to support at least a portion of the exercise equipment product when the second planar portion of the structural frame of the exercise machine product is parallel to the smooth floor surface and the exercise equipment product is in a storage position; and
c) a locking actuator on each of the at least three lockable suction cups that is actuatable between an unlocked position and a locked position causing the at least two lockable suction cups on the first planar portion of the exercise equipment product to create a suction against the smooth floor surface in the locked position, thereby causing at least a portion of the exercise equipment product to be adhered to the smooth floor surface when the exercise equipment product in in the operational position, and causing the third lockable suction cup on the second planar portion of the exercise equipment product to create a suction against the smooth floor surface in the locked position, thereby causing at least a portion of the exercise equipment product to be adhered to the smooth floor surface when the exercise equipment product in in the storage position.

18. The mechanical system of claim 17, wherein the locking actuator comprises a lever, switch, button, or pin for actuating the locking actuator.

19. The mechanical system of claim 17, wherein the at least two lockable suction cups each comprise a flexible membrane that expands to create a suction against the smooth floor surface when the locking actuator is actuated to the locked position and that contracts and releases the suction against the smooth floor surface when the locking actuator is actuated to the unlocked position.

20. The mechanical system of claim 17, wherein the exercise equipment product is selected from the group consisting of stationary bicycles, elliptical exercise machines, stair climbing machines, ladder climbing machines, treadmills, rowing machines, body weight resisted benches and racks, multi-function exercise machines, benches and racks that support barbells, weight stack resisted exercise machines, flywheel resisted exercise machines, pneumatically resisted exercise machines, magnetically resisted exercise machines, fluid resisted exercise machines, spring resisted exercise machines, cable resistance exercise machines, belt resistance machines, tire flipping machines, and boxing simulators.
